(19) United States
(12) Patent Application Publication
(10) Pub. No.: US 2024/0177176 A1
(43) Pub. Date: May 30, 2024

(54) DYNAMIC FEATURE-BASED FLEXIBLE LICENSING SYSTEM

(71) Applicant: Dell Products L.P., Round Rock, TX (US)

(72) Inventors: Ramya Ramakrishnan, Bangalore (IN); Sunil Shriram Khannade, Bangalore (IN); Abhirup Seal, Bengaluru (IN)

(21) Appl. No.: 18/071,064

(22) Filed: Nov. 29, 2022

(51) Int. Cl. G06Q 30/018

(52) U.S. Cl. CPC G06Q 30/018

(57) ABSTRACT

An information handling system receives a request from a user for a license to enable a feature of a product for a duration, and determines whether the user is authorized to enable the feature of the product for the duration. The system also determines that the user has sufficient points to enable the feature for the duration, and if both conditions are met then enables the feature of the product for the duration and adding the license to a collection of licenses.

### FIELD OF THE DISCLOSURE

The present disclosure generally relates to information handling systems, and more particularly relates to a dynamic feature-based flexible licensing system.

### BACKGROUND

As the value and use of information continues to increase, individuals and businesses seek additional ways to process and store information. One option is an information handling system. An information handling system generally processes, compiles, stores, or communicates information or data for business, personal, or other purposes. Technology and information handling needs and requirements can vary between different applications. Thus, information handling systems can also vary regarding what information is handled, how the information is handled, how much information is processed, stored, or communicated, and how quickly and efficiently the information can be processed, stored, or communicated. The variations in information handling systems allow information handling systems to be general or configured for a specific user or specific use such as financial transaction processing, airline reservations, enterprise data storage, or global communications. In addition, information handling systems can include a variety of hardware and software resources that can be configured to process, store, and communicate information and can include one or more computer systems, graphics interface systems, data storage systems, networking systems, and mobile communication systems. Information handling systems can also implement various virtualized architectures. Data and voice communications among information handling systems may be via networks that are wired, wireless, or some combination.

### SUMMARY

An information handling system receives a request from a user for a license to enable a feature of a product for a duration, and determines whether the user is authorized to enable the feature of the product for the duration. The system also determines that the user has sufficient points to enable the feature for the duration, and if both conditions are met then enables the feature of the product for the duration and adding the license to a collection of licenses.

### BRIEF DESCRIPTION OF THE DRAWINGS

It will be appreciated that for simplicity and clarity of illustration, elements illustrated in the Figures are not necessarily drawn to scale. For example, the dimensions of some elements may be exaggerated relative to other elements. Embodiments incorporating teachings of the present disclosure are shown and described with respect to the drawings herein, in which:

FIG. 1 is a block diagram illustrating an information handling system according to an embodiment of the present disclosure;

FIG. 2 is a block diagram illustrating a dynamic feature-based flexible licensing system, according to an embodiment of the present disclosure; and

FIG. 3 is a flowchart illustrating a method for a dynamic feature-based flexible licensing system, according to an embodiment of the present disclosure.

The use of the same reference symbols in different drawings indicates similar or identical items.

### DETAILED DESCRIPTION OF THE DRAWINGS

The following description in combination with the Figures is provided to assist in understanding the teachings disclosed herein. The description is focused on specific implementations and embodiments of the teachings and is provided to assist in describing the teachings. This focus should not be interpreted as a limitation on the scope or applicability of the teachings.

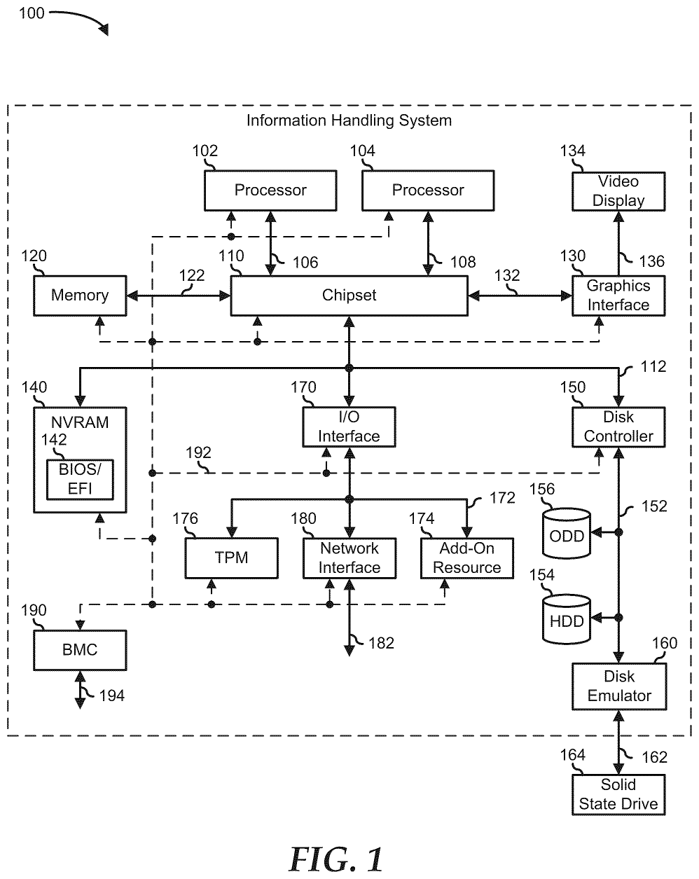

FIG. 1 illustrates an embodiment of an information handling system 100 including processors 102 and 104, a chipset 110, a memory 120, a graphics adapter 130 connected to a video display 134, a non-volatile RAM (NV-RAM) 140 that includes a basic input and output system/extensible firmware interface (BIOS/EFI) module 142, a disk controller 150, a hard disk drive (HDD) 154, an optical disk drive 156, a disk emulator 160 connected to a solid-state drive (SSD) 164, an input/output (I/O) interface 170 connected to an add-on resource 174 and a trusted platform module (TPM) 176, a network interface 180, and a baseboard management controller (BMC) 190. Processor 102 is connected to chipset 110 via processor interface 106, and processor 104 is connected to the chipset via processor interface 108. In a particular embodiment, processors 102 and 104 are connected together via a high-capacity coherent fabric, such as a HyperTransport link, a QuickPath Interconnect, or the like. Chipset 110 represents an integrated circuit or group of integrated circuits that manage the data flow between processors 102 and 104 and the other elements of information handling system 100. In a particular embodiment, chipset 110 represents a pair of integrated circuits, such as a northbridge component and a southbridge component. In another embodiment, some or all of the functions and features of chipset 110 are integrated with one or more of processors 102 and 104.

Memory 120 is connected to chipset 110 via a memory interface 122. An example of memory interface 122 includes a double data rate (DDR) memory channel and memory 120 represents one or more DDR dual in-line memory modules (DIMMs). In a particular embodiment, memory interface 122 represents two or more DDR channels. In another embodiment, one or more of processors 102 and 104 include a memory interface that provides a dedicated memory for the processors. A DDR channel and the connected DDR DIMMs can be in accordance with a particular DDR standard, such as a DDR3 standard, a DDR4 standard, a DDR5 standard, or the like.

Memory 120 may further represent various combinations of memory types, such as dynamic random access memory (DRAM) DIMMs, static random access memory (SRAM) DIMMs, non-volatile DIMMs (NV-DIMMs), storage class memory devices, read-only memory (ROM) devices, or the like. Graphics adapter 130 is connected to chipset 110 via a graphics interface 132 and provides a video display output 136 to a video display 134. An example of a graphics interface 132 includes a Peripheral Component Interconnect-Express (PCIe) interface and graphics adapter 130 can include a four-lane (×4) PCIe adapter, an eight-lane (×8) PCIe adapter, a 16-lane (×16) PCIe adapter, or another configuration, as needed or desired. In a particular embodiment, graphics adapter 130 is provided down on a system printed circuit board (PCB). Video display output 136 can include a Digital Video Interface (DVI), a High-Definition Multimedia Interface (HDMI), a DisplayPort interface, or the like, and video display 134 can include a monitor, a smart television, an embedded display such as a laptop computer display, or the like.

NV-RAM 140, disk controller 150, and I/O interface 170 are connected to chipset 110 via an I/O channel 112. An example of I/O channel 112 includes one or more point-to-point PCIe links between chipset 110 and each of NV-RAM 140, disk controller 150, and I/O interface 170. Chipset 110 can also include one or more other I/O interfaces, including a PCIe interface, an Industry Standard Architecture (ISA) interface, a Small Computer Serial Interface (SCSI) interface, an Inter-Integrated Circuit (I²C) interface, a System Packet Interface (SPI), a Universal Serial Bus (USB), another interface, or a combination thereof. NV-RAM 140 includes BIOS/EFI module 142 that stores machine-executable code (BIOS/EFI code) that operates to detect the resources of information handling system 100, to provide drivers for the resources, to initialize the resources, and to provide common access mechanisms for the resources. The functions and features of BIOS/EFI module 142 will be further described below.

Disk controller 150 includes a disk interface 152 that connects the disc controller to a hard disk drive (HDD) 154, to an optical disk drive (ODD) 156, and to disk emulator 160. An example of disk interface 152 includes an Integrated Drive Electronics (IDE) interface, an Advanced Technology Attachment (ATA) such as a parallel ATA (PATA) interface or a serial ATA (SATA) interface, a SCSI interface, a USB interface, a proprietary interface, or a combination thereof. Disk emulator 160 permits SSD 164 to be connected to information handling system 100 via an external interface 162. An example of external interface 162 includes a USB interface, an institute of electrical and electronics engineers (IEEE) 1394 (Firewire) interface, a proprietary interface, or a combination thereof. Alternatively, SSD 164 can be disposed within information handling system 100.

I/O interface 170 includes a peripheral interface 172 that connects the I/O interface to add-on resource 174, to TPM 176, and to network interface 180. Peripheral interface 172 can be the same type of interface as I/O channel 112 or can be a different type of interface. As such, I/O interface 170 extends the capacity of I/O channel 112 when peripheral interface 172 and the I/O channel are of the same type, and the I/O interface translates information from a format suitable to the I/O channel to a format suitable to the peripheral interface 172 when they are of a different type. Add-on resource 174 can include a data storage system, an additional graphics interface, a network interface card (NIC), a sound/video processing card, another add-on resource, or a combination thereof. Add-on resource 174 can be on a main circuit board, on separate circuit board or add-in card disposed within information handling system 100, a device that is external to the information handling system, or a combination thereof.

Network interface 180 represents a network communication device disposed within information handling system 100, on a main circuit board of the information handling system, integrated onto another component such as chipset 110, in another suitable location, or a combination thereof. Network interface 180 includes a network channel 182 that provides an interface to devices that are external to information handling system 100. In a particular embodiment, network channel 182 is of a different type than peripheral interface 172, and network interface 180 translates information from a format suitable to the peripheral channel to a format suitable to external devices.

In a particular embodiment, network interface 180 includes a NIC or host bus adapter (HBA), and an example of network channel 182 includes an InfiniBand channel, a Fibre Channel, a Gigabit Ethernet channel, a proprietary channel architecture, or a combination thereof. In another embodiment, network interface 180 includes a wireless communication interface, and network channel 182 includes a Wi-Fi channel, a near-field communication (NFC) channel, a Bluetooth® or Bluetooth-Low-Energy (BLE) channel, a cellular based interface such as a Global System for Mobile (GSM) interface, a Code-Division Multiple Access (CDMA) interface, a Universal Mobile Telecommunications System (UMTS) interface, a Long-Term Evolution (LTE) interface, or another cellular based interface, or a combination thereof. Network channel 182 can be connected to an external network resource (not illustrated). The network resource can include another information handling system, a data storage system, another network, a grid management system, another suitable resource, or a combination thereof.

BMC 190 is connected to multiple elements of information handling system 100 via one or more management interface 192 to provide out of band monitoring, maintenance, and control of the elements of the information handling system. As such, BMC 190 represents a processing device different from processor 102 and processor 104, which provides various management functions for information handling system 100. For example, BMC 190 may be responsible for power management, cooling management, and the like. The term BMC is often used in the context of server systems, while in a consumer-level device a BMC may be referred to as an embedded controller (EC). A BMC included at a data storage system can be referred to as a storage enclosure processor. A BMC included in a chassis of a blade server can be referred to as a chassis management controller and embedded controllers included in the blades of the blade server can be referred to as blade management controllers. Capabilities and functions provided by BMC 190 can vary considerably based on the type of information handling system. BMC 190 can operate in accordance with an Intelligent Platform Management Interface (IPMI). Examples of BMC 190 include an Integrated Dell® Remote Access Controller (iDRAC).

Management interface 192 represents one or more out-of-band communication interfaces between BMC 190 and the elements of information handling system 100, and can include an Inter-Integrated Circuit (I2C) bus, a System Management Bus (SMBUS), a Power Management Bus (PMBUS), a Low Pin Count (LPC) interface, a serial bus such as a Universal Serial Bus (USB) or a Serial Peripheral Interface (SPI), a network interface such as an Ethernet interface, a high-speed serial data link such as a PCIe interface, a Network Controller Sideband Interface (NC-SI), or the like. As used herein, out-of-band access refers to operations performed apart from a BIOS/operating system execution environment on information handling system 100, that is apart from the execution of code by processors 102 and 104 and procedures that are implemented on the information handling system in response to the executed code.

BMC 190 operates to monitor and maintain system firmware, such as code stored in BIOS/EFI module 142, option ROMs for graphics adapter 130, disk controller 150, add-on resource 174, network interface 180, or other elements of information handling system 100, as needed or desired. In particular, BMC 190 includes a network interface 194 that can be connected to a remote management system to receive firmware updates, as needed or desired. Here, BMC 190 receives the firmware updates, stores the updates to a data storage device associated with the BMC, transfers the firmware updates to NV-RAM of the device or system that is the subject of the firmware update, thereby replacing the currently operating firmware associated with the device or system, and reboots information handling system, whereupon the device or system utilizes the updated firmware image.

BMC 190 utilizes various protocols and application programming interfaces (APIs) to direct and control the processes for monitoring and maintaining the system firmware. An example of a protocol or API for monitoring and maintaining the system firmware includes a graphical user interface (GUI) associated with BMC 190, an interface defined by the Distributed Management Taskforce (DMTF) (such as a Web Services Management (WSMan) interface, a Management Component Transport Protocol (MCTP) or, a RedfishR interface), various vendor defined interfaces (such as a Dell EMC Remote Access Controller Administrator (RACADM) utility, a Dell EMC OpenManage Enterprise, a Dell EMC OpenManage Server Administrator (OMSS) utility, a Dell EMC OpenManage Storage Services (OMSS) utility, or a Dell EMC OpenManage Deployment Toolkit (DTK) suite), a BIOS setup utility such as invoked by a “F2” boot option, or another protocol or API, as needed or desired.

In a particular embodiment, BMC 190 is included on a main circuit board (such as a baseboard, a motherboard, or any combination thereof) of information handling system 100 or is integrated onto another element of the information handling system such as chipset 110, or another suitable element, as needed or desired. As such, BMC 190 can be part of an integrated circuit or a chipset within information handling system 100. An example of BMC 190 includes an iDRAC, or the like. BMC 190 may operate on a separate power plane from other resources in information handling system 100. Thus BMC 190 can communicate with the management system via network interface 194 while the resources of information handling system 100 are powered off. Here, information can be sent from the management system to BMC 190 and the information can be stored in a RAM or NV-RAM associated with the BMC. Information stored in the RAM may be lost after power-down of the power plane for BMC 190, while information stored in the NV-RAM may be saved through a power-down/power-up cycle of the power plane for the BMC.

Information handling system 100 can include additional components and additional busses, not shown for clarity. For example, information handling system 100 can include multiple processor cores, audio devices, and the like. While a particular arrangement of bus technologies and interconnections is illustrated for the purpose of example, one of skill will appreciate that the techniques disclosed herein are applicable to other system architectures. Information handling system 100 can include multiple central processing units (CPUs) and redundant bus controllers. One or more components can be integrated together. Information handling system 100 can include additional buses and bus protocols, for example, I2C and the like. Additional components of information handling system 100 can include one or more storage devices that can store machine-executable code, one or more communications ports for communicating with external devices, and various input and output (I/O) devices, such as a keyboard, a mouse, and a video display.

For purposes of this disclosure information handling system 100 can include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, information handling system 100 can be a personal computer, a laptop computer, a smartphone, a tablet device or other consumer electronic device, a network server, a network storage device, a switch, a router, or another network communication device, or any other suitable device and may vary in size, shape, performance, functionality, and price. Further, information handling system 100 can include processing resources for executing machine-executable code, such as processor 102, a programmable logic array (PLA), an embedded device such as a System-on-a-Chip (SoC), or other control logic hardware. Information handling system 100 can also include one or more computer-readable media for storing machine-executable code, such as software or data.

The inventors have recognized that manufacturers, producers, vendors and resellers of hardware and software systems may require a customer, such as an individual or an enterprise, to purchase licenses to use their product. Generally, a license supports a set of features for a price that typically increases as the number of supported features increases. The user may select from fixed sets of features offered. The user typically does not have the flexibility to purchase a feature from one fixed set and another feature from another fixed set. The user typically purchases the fixed set that supports all his required features even if the fixed set includes features that the user does not need or desire. Accordingly, the user may have to buy or upgrade to a more expensive fixed set of features to be able to purchase the user's desired features impacting user satisfaction. In another example, if the user wants to use a subset of features that spans across the three fixed sets of features, the user may be forced to buy all three fixed sets.

In a similar fashion, when an enterprise purchased licenses for their employees, the enterprise may not know which feature one employee would use versus another employee. Further, the needs of its employees may change over time which would result in the need or desire of the employees to have additional features. Under current licensing systems, the company may purchase the more expensive set of features to accommodate its employees even if this set of features may no longer be needed or desired in the future. Thus, there is a need for a flexible licensing scheme wherein a customer may purchase a license to use a set of product features á la carte at run time.

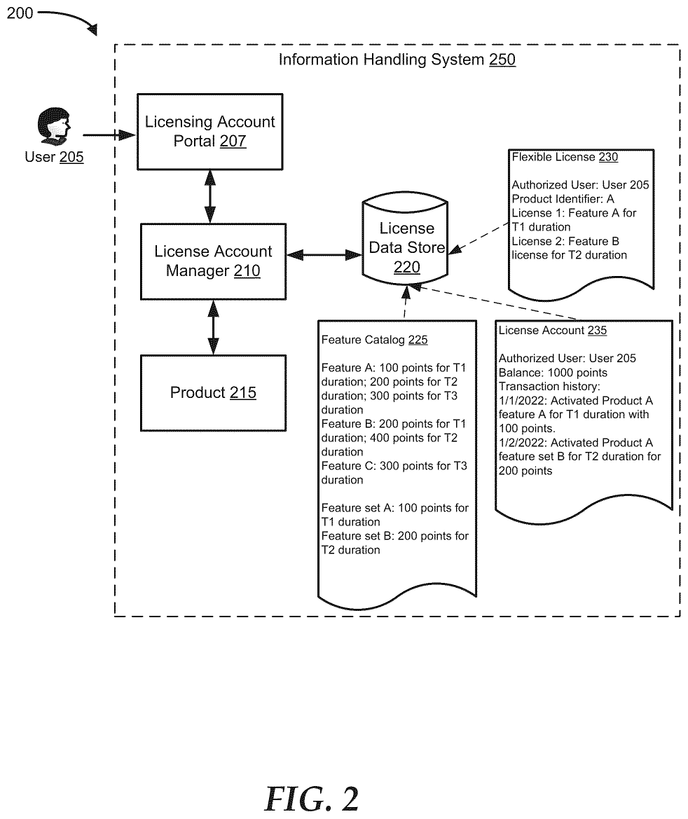

FIG. 2 illustrates a system 200 for a feature-based flexible licensing scheme, wherein a user can purchase a desired feature dynamically at run time. System 200 includes an information handling system 250 that is similar to information handling system 100 of FIG. 1. Information handling system 250 includes a licensing account portal 207, a license account manager, a product 215, and a license data store 220. System 200 may be configured to allow users to select and enable a feature or a combination of features for a specified duration. Although licensing account portal 207, license account manager, a product 215, and license store 220 are local to information handling system 250, one or more of these components may be located remotely. The components of system 200 may be implemented in hardware, software, firmware, or any combination thereof. In addition, the components shown are not drawn to scale and system 200 may include additional or fewer components. In addition, connections between components may be omitted for descriptive clarity.

User 205 may be an enterprise, an end user, or a group of end users of product 215. After purchasing 215, user 205 may transmit a request at runtime to enable one or more features of product 215 by purchasing a feature license via licensing account portal 207. In one embodiment, user 205 may log in to licensing account portal 207 to purchase the feature license. The feature license may grant user 205 a right to use the requested feature for a particular duration. Generally, a license, such as a feature license and a flexible license, specifies parameters of permission granted by an owner, like a software producer or hardware manufacturer, to the user. These parameters may assign terms to use the feature for the customer, such as user 205, for a pre-defined time. When initiating the request, user 205 may provide information, such as a user identifier, service tag associated with information handling system 250, security key or digital certificate, product identifier, etc. to identify the user and/or the product.

Licensing account portal 207 may be an interface, such as a graphical user interface or application programming interface associated with license account manager 210 configured to allow users to manage licenses, such as purchasing, importing, exporting, or downloading licenses for one or more products, such as product 215. Licensing account portal 207 may be an interface defined by DMTF, a vendor (such as RACADM utility), a BIOS setup utility, or similar. For example, the request may be transmitted by licensing account portal 207 to license account manager 210 via a hypertext transfer (HTTP), an API, or similar.

License account manager 210 may be configured to validate and process requests from licensing portal 207 upon receipt. Validating the request may include determining whether user 205 is an authorized user of product 215. If user 205 is authorized, then license account manager 210 may process the request. Otherwise, if user 205 is unauthorized, then license account manager 210 may deny the request. In addition, license account manager 210 may determine whether the requested feature is a feature of product 215 by checking a feature catalog 225 which lists the features of one or more products in information handling system 250. License account manager 210 may also determine whether user 205 is authorized to use the requested feature and to track the user's usage of the feature. For example, license account manager 210 may update flexible license 230 or deactivate the license when the license expires.

In processing the request, license account manager 210 may determine how many points may be used to purchase usage of the feature for the requested duration. In addition, license account manager 210 may determine whether user 205 has enough points for the request. For example, license account manager 210 may check license account 235 which includes information associated with user 205, such as available points and transaction history. Each feature of a product may have different pricing or value based on the feature and/or length of usage. For example, a first feature may cost one hundred points for one week while using the first feature for two weeks may cost two hundred points. However, a second feature may cost two hundred points for one week and three hundred points for two weeks.

If user 205 has enough points available to enable the requested feature, then license account manager 210 may approve the request. Otherwise, license account manager 210 may disapprove the request. If the request is approved, the feature license, which includes the right to enable the requested feature for the duration, may be added to flexible license 230. The points used in the request may be deducted from the available points at license account 235. When the duration of the added license is expired, license account manager 210 may remove the added feature license. Thus, flexible license 230 may include active feature licenses. In another embodiment, expired feature licenses included in flexible license 230 may remain but would be inactivated. Thus, flexible license 230 may include a set of feature licenses, whether active or inactive.

License account manager 210 may also manage and maintain a data store or a library, such as license data store 220 that stores flexible license 230, feature catalog 225, and license account 235. Further, license data store 220 may store user profiles and other information for the purchase and management of flexible licenses. License data store 220 may be a persistent data storage device and may include a solid state disk, hard disk drive, magnetic tape library, optical disk drive, magneto-optical disk drive, compact disk drive, disk array, non-volatile memory, and/or any computer-readable medium to store data.

Product 215 may be a hardware component, software application, digital content, electronic information, electronic files, etc. which can use a dynamic feature-based licensing system. Product 215 may come with a pre-installed perpetual flexible license with an initial balance of zero points. For example, product 215 may be an iDRAC included in an embedded controller, such as BMC 190 of FIG. 1. Additional points may be purchased by user 205 via licensing account portal 207 which is provided and maintained by license account manager 210. The purchase price of the points may be based on the feature and duration of the license's validity. For example, a thousand points with one-month validity may be purchased for ten dollars while two thousand points that are valid for three months may be purchased for fifteen dollars. The points may be a digital object used as an exchange value to enable a set of features of one or more products that are configured to use the flexible licensing scheme. Aside from purchasing points, the points may also be imported and/or exported. For example, an enterprise may allocate a certain number of points for its employees to use.

Flexible license 230, also referred to herein after simply as a license, may be a collection of feature licenses purchased for one or more features or a set of features of product 215. Thus, the flexible license may include a set of licenses which enables different features for different durations. For example, a feature license may allow a customer to use certain features of a software application or hardware component of an information handling system, such as processor speed or a number of processors. For example, as shown in product “A” flexible license 230, or simply license 230, may authorize user 205 to use feature A for T1 duration and feature B for T2 duration. User 205 may renew one or more feature licenses for another duration. User 205 may also remove the authorization to use one of the features before the end of the authorized duration. User may send another request to purchase the ability to use another feature of product 215 or a different product. If the request is successful, then another feature license may be added to flexible license 230 and the feature enabled for the purchased duration.

Flexible license 230 may be a point-based license with the flexibility of being updated with additional feature licenses at runtime. One or more feature licenses may also be removed at runtime. Flexible license 230, also referred to herein simply as a license, maybe a collection of dynamic individual feature licenses, wherein each of the individual feature licenses may be for one or more features of product 215. In another embodiment, flexible license 230 may be a collection of feature licenses for a plurality of products. Each feature license may include information that defines certain parameters, such as what feature the feature license is for, how long the feature is enabled for, which information handling system the feature license can be used, the identity of the customer that the feature is authorized for, etc. Flexible license can be in a license file format stored locally, such as at license data store 220 or on a remote license server or data store. The feature may be enterprise-level features or non-enterprise-level features. Flexible license 230 may be of various formats, such as an extensible markup language, JavaScript Object Notation, third-party propriety license format, binary file, etc.

With flexible license 230 including a set of feature licenses allows a product manufacturer to maintain one flexible license for each product instead of several different licenses. In addition, the flexible licensing model may allow the customer to scale up by enabling or activating additional features at runtime. The customer may also scale down by disabling or deactivating features at runtime. As such, the flexible license may be used for all the features offered for a particular product or a subset thereof. In one embodiment, related features may be grouped into a set of features that can be enabled or activated together. Additional features may be added to the set. Accordingly, features may be removed from the set, such as when the product no longer supports a feature.

Although the illustrations show the usage of a point system in activating certain features of a product for use by a customer. The flexible licensing system may use any type of unit with a value that can be allocated to enable or activate the feature for a duration. For example, instead of using points, the flexible licensing system may use a monetary system, tokens, or similar. Further, although feature catalog 225, license account 235, and flexible license 230 are illustrated as files, the aforementioned may be a different data structure. For example, feature catalog 225 and license account 235 may be a table, a list, a map, a database, and other data structure that is capable of associating parameters. For example, each feature in feature catalog 225 may be associated with corresponding points for a particular duration.

While the explanations may relate to a particular software product, it is to be appreciated that embodiments are not limited to this particular software product or licensing implementation scenarios. For example, a flexible licensing model may be used in licensing hardware devices or components, such as BMC 190 of FIG. 1 that may not be accessible via a public network.

Those of ordinary skill in the art will appreciate that the configuration, hardware, and/or software components of system 200 depicted in FIG. 2 may vary. For example, the illustrative components within system 200 are not intended to be exhaustive, but rather are representative to highlight components that can be utilized to implement aspects of the present disclosure. For example, other devices and/or components may be used in addition to or in place of the devices/components depicted. In addition, in certain embodiments, all or a portion of the functionality provided by the illustrated components may instead be provided by components integrated into one or more processor(s) as a system-on-a-chip. The depicted example does not convey or imply any architectural or other limitations with respect to the presently described embodiments and/or the general disclosure. In the discussion of the figures, reference may also be made to components illustrated in other figures for the continuity of the description.

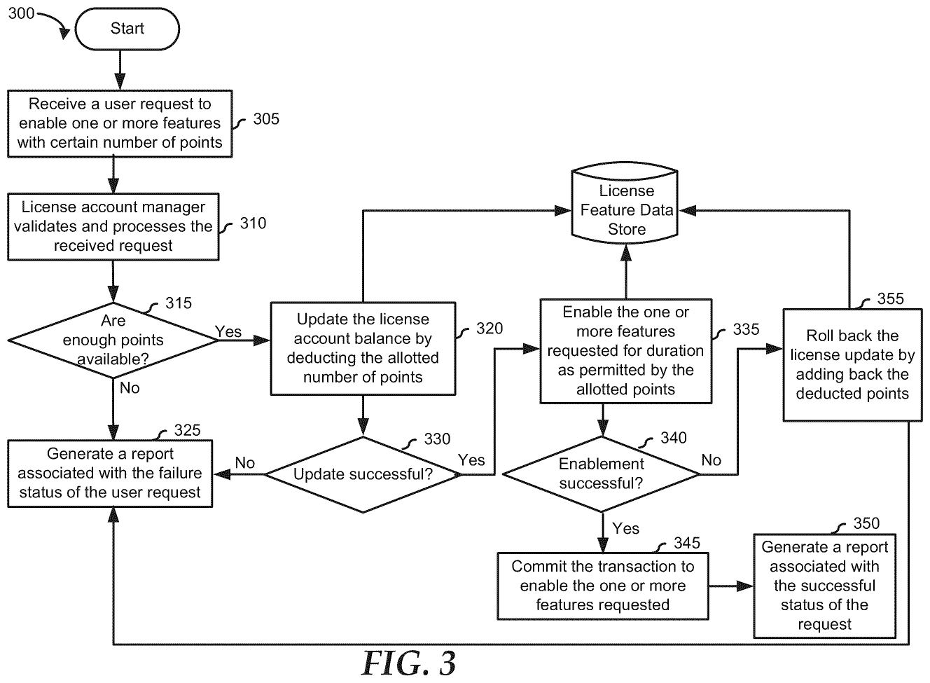

FIG. 3 illustrates a method 300 for enabling just-in-time product features via a flexible licensing model. Based on this flexible licensing model, a requested feature may be activated or enabled for usage at the point in time that the customer desires to use the feature. The feature may be used by the customer for a period based on the allocated points according to a pricing scheme. Additional features may be activated or enabled at any point in time as desired by the customer. Method 300 may be performed by one or more components of system 200 of FIG. 2, such as license account manager 210. However, while embodiments of the present disclosure are described in terms of system 200 of FIG. 2, it should be recognized that other systems may be utilized to perform the described method. One of skill in the art will appreciate that this flowchart explains a typical example, which can be extended to advanced applications or services in practice.

Method 300 typically starts at block 305 where the license account manager receives a request from a user to enable one or more features. In one embodiment, the user may utilize a licensing account portal to send the request. In another embodiment, the request may be transmitted via a software provider, a software source, or an intermediary, such as a software distributor or reseller who handles the request directly or conveys the request to the software source, and so on. The user may purchase points with valid duration. For example, the user may purchase one thousand points with one month validity for price. The user may purchase two thousand points value with a longer valid duration with more money. Each feature may have different pricing options based on usage. For example, to use a feature for one week, the user may use a certain number of points. If the user wants to use that feature for two weeks, then the user may have to use more points. In another example, to use a different feature for one week, the user may more or less than the first feature. The pricing option may also include unlimited or lifetime usage of one or more features for a certain number of points.

At block 310, the method may validate and process the received request. A license account manager may validate whether the request and/or the user is valid and authorized to use the license. The license account manager may obtain user information, such as customer number, and user identifier information like the user's IP address, login name, password, etc. In one embodiment, the system may query a user profile to obtain the aforementioned or other information associated with the user, such as the user's system configuration, a user's server identifier, reseller information, licenses consumed, licenses available, the number of points consumed, user's service tag, etc. The license account manager may also authenticate the request, such as via a digital certificate or keys attached to the request. The license account manager may also determine whether the user is permitted to use the requested feature or software. The license account manager may also determine the license account balance, or the number of available points that can be used for the request. In addition, the license account manager may determine the pricing option associated with the requested feature, the number of points required for the request.

The method proceeds to decision block 315, where the method determines if there are enough points available to fulfill the request. If there are enough points available, then the method may take the “YES” branch and proceed to block 320. If there are not enough points available, then the method may take the “NO” branch and proceed to block 325.

At block 320 the method may update the license account balance by deducting the number of points allotted to the request as determined by the license account manager. At block 325, the method generates a report associated with the failure to process the user request successfully. The method may also query whether the user would like to purchase additional points. If the user would like to purchase additional points, then the method may loop back to decision block 315.

At decision block 330, the method may determine whether the update is successful. If the update is successful, then the “YES” branch is taken, and the method proceeds to block 335. If the update is not successful, then the “NO” branch is taken, and the method proceeds to block 325. At block 335, the method enables a set of requested features for the duration as permitted by the allotted points. At decision block 340, the method determines whether the enablement of the set of requested features is successful. If the enablement is successful, then the “YES” branch is taken, and the method proceeds to block 345. If the enablement is not successful, then the “NO” branch is taken, and the method proceeds to block 355.

At block 355 the method rolls back the license update transaction performed at block 320 by adding the deducted points to the license account balance. Whereas at block 345, the transaction associated with enabling the set of features in the request is committed. At block 350, the method generates a report that the user request has been processed successfully. At this point, the user may be able to use the enabled feature for the specified time based on the allotted points.

Although FIG. 3 shows example blocks of method 300 in some implementations, method 300 may include additional blocks, fewer blocks, different blocks, or differently arranged blocks than those depicted in FIG. 3. Those skilled in the art will understand that the principles presented herein may be implemented in any suitably arranged processing system. Additionally, or alternatively, two or more of the blocks of method 300 may be performed in parallel. For example, block 345 and block 350 of method 300 may be performed in parallel.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionalities as described herein.

When referred to as a “device,” a “module,” a “unit,” a “controller,” or the like, the embodiments described herein can be configured as hardware. For example, a portion of an information handling system device may be hardware such as, for example, an integrated circuit (such as an Application Specific Integrated Circuit (ASIC), a Field Programmable Gate Array (FPGA), a structured ASIC, or a device embedded in a larger chip), a card (such as a Peripheral Component Interface (PCI) card, a PCI-express card, a Personal Computer Memory Card International Association (PCMCIA) card, or other such expansion card), or a system (such as a motherboard, a system-on-a-chip (SoC), or a stand-alone device).

The present disclosure contemplates a computer-readable medium that includes instructions or receives and executes instructions responsive to a propagated signal; so that a device connected to a network can communicate voice, video, or data over the network. Further, the instructions may be transmitted or received over the network via the network interface device.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tape, or another storage device to store information received via carrier wave signals such as a signal communicated over a transmission medium. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

Although only a few exemplary embodiments have been described in detail above, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents but also equivalent structures.

What is claimed is:

1. A method comprising:
receiving, by a processor, a request from a user for a license to enable a feature of a product for a duration;
determining whether the user is authorized to enable the feature of the product for the duration;
determining whether the user has sufficient points to enable the feature for the duration; and
in response to determining that the user is authorized and has sufficient points, enabling the feature of the product for the duration and adding the license to a collection of licenses.

2. The method of claim 1, wherein the collection of licenses includes a set of licenses that are associated with a set of features.

3. The method of claim 1, further comprising determining a number of points to enable the feature for the duration.

4. The method of claim 1, wherein the collection of licenses is pre-installed in the product.

5. The method of claim 1, wherein the request includes a service tag of an information handling system of the user wherein the product is installed.

6. The method of claim 1, further comprising updating a license account balance of the user by deducting the points used to enable the feature for the duration.

7. The method of claim 1, further comprising determining whether enabling the feature of the product is successful.

8. The method of claim 1, further comprising rolling back the license in response to a failure in enabling the feature of the product.

9. The method of claim 1, further comprising in response to determining that the license expired, removing the license from the collection of licenses.

10. An information handling system, comprising:
a processor; and
a memory that includes instructions that when executed cause the processor to perform operations including:
receiving a request from a user for a license to enable a feature of a product for a duration;
determining whether the user is authorized to enable the feature of the product for the duration;
determining that the user has sufficient points to enable the feature for the duration; and
in response to determining that the user is authorized and has sufficient points, enabling the feature of the product for the duration and adding the license to a collection of licenses.

11. The information handling system of claim 10, wherein the collection of licenses includes a set of licenses associated with a set of features.

12. The information handling system of claim 10, the operations further comprising updating a license account balance of the user by deducting the points used to enable the feature for the duration.

13. The information handling system of claim 10, the operations further comprising rolling back the license in response to a failure in enabling the feature of the product.

14. The information handling system of claim 10, the operations further comprising in response to determining that the license expired, removing the license from the collection of licenses.

15. A non-transitory computer-readable medium to store instructions that are executable to perform operations comprising:
receiving a request from a user for a license to enable a feature of a product for a duration; and
if the user is authorized to enable the feature of the product for the duration, and if the user has sufficient points to enable the feature for the duration, then enabling the feature of the product for the duration and adding the license to a collection of licenses.

16. The non-transitory computer-readable medium of claim 15, wherein the collection of licenses includes a set of licenses associated with a set of features.

17. The non-transitory computer-readable medium of claim 15, the operations further comprising updating a license account balance of the user by deducting the points used to enable the feature for the duration.

18. The non-transitory computer-readable medium of claim 15, the operations further comprising rolling back the license in response to a failure in enabling the feature of the product.

19. The non-transitory computer-readable medium of claim 15, the operations further comprising in response to determining that the license expired, removing the license from the collection of licenses.
